(19) United States
(12) Patent Application Publication
(10) Pub. No.: US 2011/0099191 A1
(43) Pub. Date: Apr. 28, 2011

(54) Systems and Methods for Generating Results Based Upon User Input and Preferences

(76) Inventors: Debashis Ghosh, Charlotte, NC (US); Kurt Newman, Matthews, NC (US); David Joa, Irvine, CA (US); Sudipta Chaki, Hartford, CT (US)

(21) Appl. No.: 12/607,383

(22) Filed: Oct. 28, 2009

(51) Int. Cl. G06F 17/30

(52) U.S. Cl. 707/769

(57) ABSTRACT

A method and system for generating search results, comprising submitting a first search query for searching a first level database that yields high level aggregated classifications, and obtaining high level aggregated classifications based upon the first search query. The submission of a second search query based upon the high legal aggregated classifications of the first search query, and obtaining focused results based upon the second search query.

### FIELD OF THE INVENTION

The present invention relates generally to networked computer systems and methods for generating results based upon user input and preferences, and more particularly the present invention relates to systems and methods that provide dynamic search results based upon parameters entered into the system and the introduction of ancillary matter into the search results based upon these parameters.

### BACKGROUND OF THE INVENTION

There are many systems, such as online search engines and e-commerce sites that search or “crawl” third party computer networks and their own networks for information to generate a listing of goods or services for a user. The user may enter a search term and the system produces results based upon a number of factors, including the amount of payment made to the owner of the system, the popularity of the search terms, etc. These types of systems are not very efficient or effective when a user is searching for a particular good, service, or information. Specifically, terms that are more narrow in scope which result in less accurate results from pre-existing search solutions. Additionally, such sites do not allow a user to modify the content produced based upon the information generated during the initial search. In other words, the user is unable to rely upon the initial search to generate a more refined and definite subsequent search.

### BRIEF SUMMARY OF THE INVENTION

In an exemplary embodiment of the present invention, a method of generating search results includes submitting a first search query for searching a first level database that yields high level aggregated classifications; obtaining high level aggregated classifications based upon the first search query; submitting a second search query based upon the high legal aggregated classifications of the first search query; and obtaining focused results based upon the second search query. The method further includes providing database of stored search terms and pages. Optionally, the method further includes submitting a third search query based upon the focused results based upon the second search query. Alternatively, the method further includes submitting an expiration date for removing results from a search. The method can further include submitting a detailed description for inclusion with the results from the search. The method further includes submitting a rank based upon experiences encountered during the search.

In another exemplary embodiment of the present invention, a method of generating search results includes providing a server and at least one user terminal that is coupled to the server, a first user and a plurality of second users; submitting a first search query by the first user for searching a first level database that yields high level aggregated classifications related to inputs from the plurality of second users; obtaining high level aggregated classifications based upon the first search query; ranking the aggregated classifications obtained for the first user; submitting a second search query by the based upon the high legal aggregated classifications of the first search query; and obtaining focused results based upon the second search query. Optionally, the first user is a buyer and the plurality of second users are sellers. The method further includes providing a database of stored terms and pages. The method can further include submitting a third search query based upon the focused results of the second search query. Optionally, the method further includes submitting an expiration date for removing results from a search. Alternatively, the method further includes displaying content relevant to the results obtained based upon the second search query. The content is searchable, thus allowing the first user to search terms contained within the content.

In yet another exemplary embodiment of the present invention, a system for generating search results includes a local interface; a data store; a processor coupled to the local interface and the data store, wherein the processor is configured to receive the submission of a first query for searching a first level database that yields high level aggregated classifications related to inputs, obtain high level aggregated classifications based upon the first search query, rank the aggregated classifications obtained, submit a second search query based upon the high level aggregated classifications, and present a search result based upon the description submitted by the seller and the search query submitted by the buyer. The system further includes memory that may be accessed by the processor. The processor is configured to allow the selection of a particular search result by the buyer based upon the search results presented. The processor is further configured for creating a matching algorithm that matches a particular good or service for sale by the seller to a good or service desired by a buyer based upon the description submitted by the seller and the search query submitted by the buyer. Optionally, the processor is configured to receive a photograph of the good offered for sale by the seller. Alternatively, the processor is configured to provide notification to the buyer or the seller that the other party wishes to communicate.

In still yet another exemplary embodiment of the present invention, a content to content method includes providing a server and at least one user terminal that is coupled to the server over a network; providing content from the server to the at least one user terminal; flagging one or more words in the content to be used as terms for a content to content search, wherein the flagging utilizes Extensible Markup Language; performing the content to content search by looking up related content based on the one or more words; and providing the related content to the at least one user terminal.

### BRIEF DESCRIPTION OF THE DRAWINGS

The present invention is illustrated and described herein with reference to the various drawings, in which like reference numbers denote like method steps and/or system components, respectively, and in which:

FIG. 1 is a block diagram of a server system.

FIG. 2 is a flow chart exemplifying the process a seller uses to list a good or service for sale on the system.

FIG. 3 is a flow chart exemplifying the process a buyer uses to inquire about a good or service they are interested in purchasing and the actual purchase of the product.

FIG. 4 is a flow chart exemplifying a search engine process utilizing a multi-layer recursive search engine.

### DETAILED DESCRIPTION OF THE INVENTION

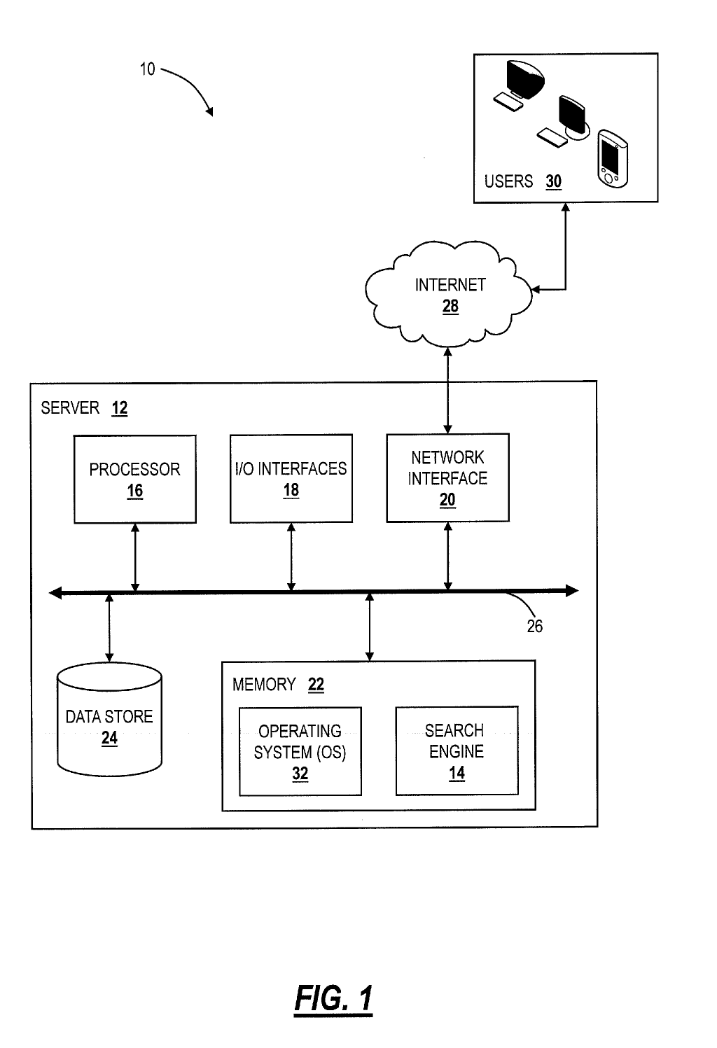

An improved system for purchasing and selling goods and services is described herein. The system is shown generally at reference numeral 10. As illustrated in FIG. 1, the system includes a server 12 having a search engine 14, according to an exemplary embodiment of the present invention. The server 12 can be a digital computer that, in terms of hardware architecture, generally includes a processor 16, input/output (I/O) interfaces 18, a network interface 20, memory 22, and a data store 24. The components (16, 18, 20, 22, and 24) are communicatively coupled via a local interface 26. The local interface 26 can be, for example but not limited to, one or more buses or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 can include address, control, and/or data connections to enable appropriate communications among the aforementioned components.

The processor 16 is a hardware device for executing software instructions. The processor 16 can be any custom made or commercially available processor, a central processing unit (CPU), an auxiliary processor among several processors associated with the server 12, a semiconductor-based microprocessor (in the form of a microchip or chip set), or generally any device for executing software instructions. When the server 12 is in operation, the processor 16 is configured to execute software stored within the memory 22, to communicate data to and from the memory 22, and to generally control operations of the server 12 pursuant to the software instructions.

The I/O interfaces 18 can be used to receive user input from and/or for providing system output to one or more devices or components. User input can be provided via, for example, a keyboard and/or a mouse. System output can be provided via a display device and a printer (not shown). I/O interfaces 18 can include, for example, a serial port, a parallel port, a small computer system interface (SCSI), an infrared (IR) interface, a radio frequency (RF) interface, and/or a universal serial bus (USB) interface.

The network interface 20 can be used to enable the server 12 to communicate on a network, such as the Internet 28. For example, the server 12 can utilize the network interface 20 to communicate to multiple users 30 over the Internet 28. The users 30 can include desktop computers connected to the Internet 28 via a high-speed connection (DSL, Cable modem, WiMax, Cellular, etc.), laptop computers connected to the Internet 28 via the high-speed connection, mobile devices connected to the Internet 28 via a mobile network, and the like. Each user 30 can also include a network interface to communicate to the server 12 to access the search engine 14. The network interface 20 can include, for example, an Ethernet card (e.g., 10BaseT, Fast Ethernet, Gigabit Ethernet) or a wireless local area network (WLAN) card (e.g., 802.11a/b/g). The network interface 20 can include address, control, and/or data connections to enable appropriate communications on the network.

A data store 24 can be used to store data, such as information for use with the search engine 14. The data store 24 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 24 can incorporate electronic, magnetic, optical, and/or other types of storage media. In one example, the data store 24 can be located internal to the server 12 such as, for example, an internal hard drive connected to the local interface 26 in the server 12. Additionally in another embodiment, the data store can be located external to the server 12 such as, for example, an external hard drive connected to the I/O interfaces 18 (e.g., SCSI or USB connection). Finally in a third embodiment, the data store 24 may be connected to the server 12 through a network, such as, for example, a network attached file server.

The memory 22 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 22 may incorporate electronic, magnetic, optical, and/or other types of storage media. Note that the memory 22 can have a distributed architecture, where various components are situated remotely from one another, but can be accessed by the processor 16.

The software in memory 22 can include one or more software programs, each of which includes an ordered listing of executable instructions for implementing logical functions. The software in the memory system 22 includes the adaptive gain control 14 engine and a suitable operating system (O/S) 32. The operating system 32 essentially controls the execution of other computer programs, such as the search engine 14, and provides scheduling, input-output control, file and data management, memory management, and communication control and related services. The operating system 28 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or the like.

The system 10 is designed to be used by any number of individuals, i.e. the users 30. In one exemplary embodiment, the system 10 is designed for facilitation and expediting the sale of goods or services. The system 10 is designed to be used by a seller of these goods and provider of these services for placement of their goods and services for sale. The system 10 is designed to allow a buyer to search for goods and services for sale by the sellers in one convenient location. The system 10 is fast, effective, and efficient.

During use, the system 10 presents to a seller a general category list of items and/or services the seller might be offering to a willing buyer. The general category list is a predetermined list of goods and/or services that are commonly bought, sold, and requested by a buyer and seller. The seller is not strictly limited to the goods and/or services found within the predetermined list, but may also add additional items should the good or service offered by the seller be absent from the predetermined list. The good or service may be added by simply entering the good or service description into an appropriate area positioned on the general category list.

Once the seller has identified the good and/or service, a separate window appears that allows the seller to enter information they believe to be the most important characteristics. The characteristics may fall into two categories. The first category being ordinal attributes. The ordinal attributes may be any preselected attribute, but preferably, the ordinal attributes represent key components of the good or service offered by the seller. For example, the ordinal attribute of a computer could be the amount of RAM, number of disk drives, speed of the CPU and the like. The second category is non-ordinal attributes. The non-ordinal attributes may be considered secondary attributes when compared to the ordinal attributes. Utilizing the above example, non-ordinal attributes for a computer may be the manufacturer of the CPU, the brand of computer, and the type of display (CRT or flat screen). Preferably, the seller may identify as many characteristics as desired.

In addition to the description of the goods and/or services, the seller may list a requested price. The requested price may be listed in any currency or multiple currencies. For example, a European seller may list the price in euros and United States dollars. Alternatively, the list price may be in Euros and the system may automatically convert the euro into other worldwide currencies. Further, the system may change the currencies daily based upon market fluctuations. The seller may also list an expiration date. This date would indicate when the offer has expired and the item will be delisted from the system if not sold by the expiration date.

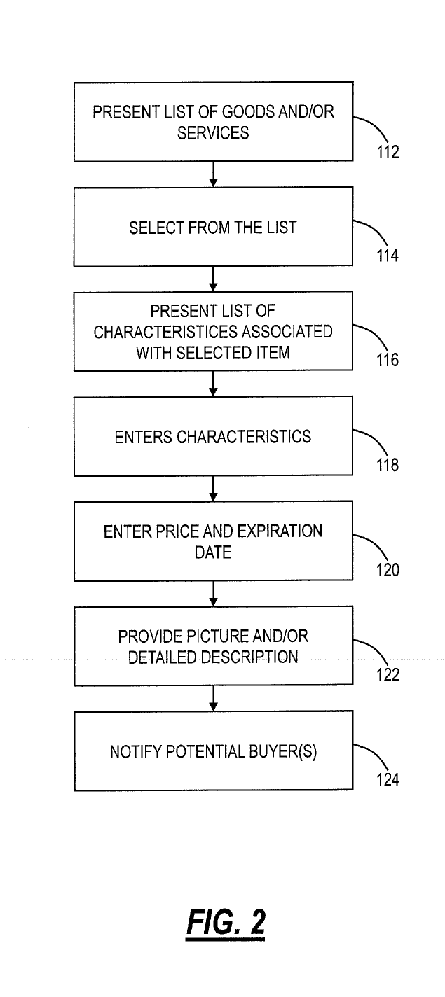

As illustrated in FIG. 2, the system 10 presents the seller with a list of goods and/or services from a predetermined list that the seller may sell within the system 10 (step 112). The seller then selects the good or service they wish to sell from the list of goods and/or services (step 114). After the selection is made, the seller is then presented with a list of characteristics for the good or service the seller is offering (step 116). The list of characteristics also includes a range of values for each characteristic. These characteristics may be ordered so they are ordinal attributes and other characteristics cannot be ordered so they are non-ordinal attributes. The list of characteristics may be based upon a predetermined list of characteristics for a certain item. The list of characteristics may also be fluid in that the list of characteristics may include characteristics other sellers have identified for the good or service. In other words, should a seller enter a characteristic on the list of characteristics not previously predetermined, the characteristic is automatically added as an option for a future seller to select on the list of characteristics.

Preferably, the seller may identify as many characteristics as they wish (step 118). Should a characteristic not be located on the list of characteristics, the seller may add the characteristic in the list of characteristics. The seller then may enter values for all of the characteristics of the good or service on the list of values. After the values are entered into the list of values the seller may enter a price they will accept for the goods or services (step 120). The price will be treated as an ordinal characteristic. An expiration date may be listed by the seller. As mentioned above, if the good or service is not sold by the expiration date, the good or service is delisted from the system. To further enhance the possibility of selling their item, the seller may upload a picture, photograph, or detailed description of the good or service they are placing for sale (step 122).

The system 10 allows the seller to be notified when a potential buyer is interested in the good or service they are attempting to sell (step 124). The notification may be sent to the seller in any form that is acceptable. Preferably, the notification is by email, text message, phone call or the like. The seller may also receive notification by more than one method. For example, the seller may receive a notification by email and text message.

When the buyer accesses the system, the buyer is presented with a list of goods or services currently offered for sale within the system. The buyer then selects a good or service from the list they are interested in purchasing. Once the buyer selects the good or service, a characteristics list is presented, which allows the buyer to select characteristics they desire for the goods or services they want to purchase. The buyer also sets a range of values for each characteristic. The characteristics may fall into two categories. The first category being ordinal attributes. The ordinal attributes may be any preselected attribute, but preferably, the ordinal attributes represent key components of the good or service offered by the seller. For example, the ordinal attributes of a computer could be the amount of RAM, number of disk drives, speed of the CPU and the like. The second category is non-ordinal attributes. The non-ordinal attributes may be considered secondary attributes when compared to the ordinal attributes. Utilizing the above example, non-ordinal attributes for a computer may be the manufacturer of the CPU, the brand of computer, and the type of display (CRT or flat screen). Preferably, the buyer may identify as many characteristics as they would like.

The system 10 allows a buyer to select characteristics that are appealing to them for their desired need. If the characteristic is ordinal (e.g the number of cpu's for the purchase of a computer) the system 10 is designed so that any values close to the selected values may be considered by the value. In other words, the buyer may select the number 2 for the number of cpus, since the characteristic is ordinal and the system is programmed to understand that the number 3, representing 3 cpus, is close to the desired 2 cpus in the match list that could potentially contain 3 cpus.

If the characteristic is non-ordinal (e.g the manufacturer of the cpu) the system is not designed to recognize how INTEL®, AMD®, ACME Super CPU, etc. relate and will be forced to discard computers that match all characteristics except the non-ordinal cpu manufacturer characteristic. All characteristics are a perfect match except the cpu manufacturer and the computer would not appear in the match list. In reality, buyers that select Intel® for a cpu manufacturer may consider AMD® if all other characteristics match. This characteristic is non-ordinal so the system will not know how to select values that are close to the preferred value. The system allows buyers to select values for non-ordinal characteristics that they will accept and then identify the one value for non-ordinal characteristics that are the preferred value. This would allow computers to be listed in the match list if they match on all characteristics except a non-ordinal preferred value.

The buyer may enter values for the characteristics they would like the matching algorithm to consider. For each characteristic presented, the buyer may choose a value based upon the needs and wants of the buyer. For non-ordinal characteristics, the buyer may identify if the value is selected is the preferred value.

The buyer may list any price range they would consider purchasing the good or service. The price range entered by the buyer would be treated as an ordinal characteristic for matching purposes. The buyer may also list an offer expiration date indicating that if the buyer fails to purchase the good or service by the expiration date, the system will cease looking for goods and services the buyer is interested in purchasing.

Once the buyer has entered the goods or services they are interested in purchasing and completely entered the characteristics, price range, and/or expiration date, the system begins searching for goods or services for sale matching the criteria entered by the buyer. The system searches for these goods or services by utilizing a matching algorithm that creates a match score. The match score is used to select goods or services for sale using the characteristics entered by the buyer. The goods or services located that match the criteria of the buyer are sorted by the match score and presented to the buyer. In other words, the system uses the match score to locate the most relevant goods or services based upon the desired characteristics of the buyer. The system presents the buyer with the goods or services in order of importance based upon the desired characteristics.

The matching algorithm uses the ranges of values for ordinal characteristics and binary flags for non-ordinal characteristics. For numeric ordinal characteristics, the matching algorithm considers all goods or services for sale where the numeric ordinal characteristic value is within +/− a user definable percentage from the value identified by the buyer. The +/− percentage will default to a definable level but the default level can be overridden if the buyer sets a specific +/− percentage level. The absolute value of the percent different difference between the buyer's preference and the characteristic entered by the seller is added to the match score. By way of example only, if the value entered by the seller is 110% of the value entered by the buyer, the matching algorithm will add 10 to the match score.

For non-ordinal characteristics, the matching algorithm considers all goods for sale that are within +/− a user definable number of categories from the value identified by the buyer. If the category selected by the buyer exactly matches the category entered by the seller, the matching algorithm adds zero to the match score. The matching algorithm adds different amounts to the match score depending on how many categories separate the value selected by the buyer and entered by the seller. For example, if the buyer has selected the term “teen age” from the characteristics list and the seller has entered “young adult.” The matching algorithm might add 10 to the match score. By way of another example, if the buyer selects the term “senior” and the seller has entered “young adult,” the matching algorithm would add 20 to the match score. If the buyer selects multiple levels, the matching algorithm will consider the levels selected to be absolute and be limited to the specific levels the buyer has selected. Zero will be added to the match score.

For non-ordinal characteristics, the matching algorithm considers the buyer's selection of preferred or absolute. If the buyer has selected preferred for the value the matching algorithm mad add zero to the match score for all items for sale where the values exactly match and the matching algorithm may add 10 to the match score for all items that do not exactly match what the buyer has selected. If the buyer has selected absolute for the value, the matching algorithm does not consider any items wherein the match for the characteristic is not exact.

The matching algorithm evaluates all characteristics identified by the buyer as being important and sums all match score adjustments to create the final score. The items for sale are rank ordered by the match score and a user definable number of best matches are displayed for the buyer with low values at the top of the list.

The buyer may also adjust the criteria upon initially receiving the results from the system. The buyer can easily adjust the values for all characteristics they would like used for the match. The buyer can also add or delete characteristics from the matching process. Once the buyer has adjusted the characteristics, the matching algorithm reevaluates all the characteristics identified by the buyer as being important and sums all match score adjustments to recreate the final match score. The list of items produced by the system changes in accordance with the buyer's adjustment in a manner that is very intuitive for the buyer. This enables the buyer to understand how their selection of characteristics and specific values for characteristics affect the list of matching goods and services.

In addition to adjusting the criteria, the buyer may enter relative importance values for each of the characteristics they would like to be used in the matching process. For example, the buyer may rank characteristics between 1 and 5, with 1 being the most important and 5 being the least important. Multiple characteristics may be assigned the same relative importance. When the matching algorithm creates the match score, the component values for all items with relative importance of 1 are multiplied by 10, 2 are multiplied by 7.5, 3 are multiplied by 5, 4 are multiplied by 2.5, and 5 are multiplied by 1. This will influence the match score to be higher for items with relative importance of 1 that are not exact matches.

When the buyer selects a good or service provided by the system from a match list, a web page is displayed that contains photographs or goods and detailed descriptions of services. The information displayed will probably include geographic location and potential shipping costs. Items that cannot be shipped will be identified as “pick up only.” If the seller has multiple items listed for sale, the buyer is able to view the goods or services of the seller by clicking on a link or the like.

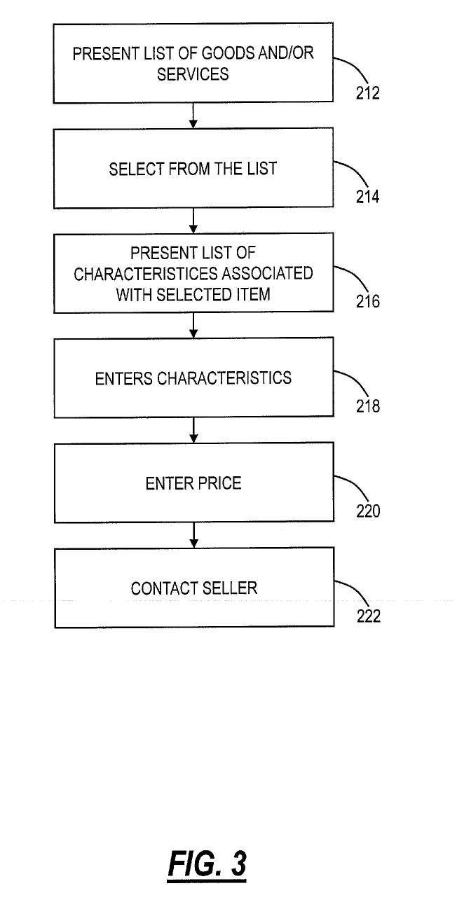

As illustrated in FIG. 3, the system 10 presents the buyer with a general list of goods and/or services currently offered for sale within the system 10 (step 212). The buyer then selects the good or service they are interested in purchasing from the list of goods and/or services (step 214). After the selection is made, the buyer is then presented with a list of characteristics for the good or service the seller is offering (step 216). The list of characteristics also includes a range of values for each characteristic. These characteristics may be ordered so they are ordinal attributes and other characteristics cannot be ordered so they are non-ordinal attributes. The list of characteristics may be based upon a predetermined list of characteristics for a certain item.

Preferably, the buyer may identify as many characteristics as they wish. The buyer then may enter values for all of the characteristics of the good or service on the list of values (step 218). After the values are entered into the list of values the buyer may enter a price they will pay for the goods or services (step 220). The price will be treated as an ordinal characteristic. An expiration date may be listed by the buyer. As mentioned above, if the good or service is not purchased by the expiration date, the good or service is delisted from the system 10.

The system 10 allows for the seller and buyer to communicate with each other (step 222). The buyer may select goods or services on the list presented by the matching algorithm to open a dialog with the seller. The buyer may then post messages for the seller. The seller and buyer can select the preferred method of receiving notification from the other. The choices include email, text message, phone call, or the like. The buyer has the option to select multiple notification methods. When a dialog is requested with a seller for a specific good or service the seller is notified and responds to any messages from a potential buyer or multiple potential buyers. The seller is then notified when the buyer responds to their message.

The email messages between the buyer and seller contain a complete email chain of all messages sent between a like seller and like buyer. The emails may only be viewed by the buyer and the seller, and are not publically available. The email message has a look very similar to known emails, but the email does not contain the correct, visible email address of either the seller or the buyer. The emails go to a system, and then, the system forwards them to the appropriate address. With this communication format, the seller and buyer do not have to log into the system to read messages. They simply communicate with each other as if the system was not acting as an intermediary. Essentially, the system facilitates email communication between buyers and sellers so the individuals can interact as if they had email addresses for each other. The system does not require individuals to adopt a new email communication process.

In summary, the email communication process of the system begins when an email is sent that includes the complete dialog concerning the specific good or service. If this is the first email to the buyer with an initial message from a buyer, it includes the message keyed into the system by the buyer. When an email is received, the new portion of the email message is automatically entered into the system as if the message had been keyed directly into the system by the buyer and seller. If the buyer or seller log into the system and type a message directly into the system, that message is included in the email sent to the other individual so the dialog is complete. The individual that receives the email will not know if the other individual responded to an email or if they logged into the system and typed the message directly into the system. They seller and buyer may be notified when the other party responds to a message. The notification methods include email, text message, phone call, or the like. The message received simply notifies the buyer or seller that the other party has responded to their prior message. The notification method does not contain a record of the dialog, but informs the buyer or seller of a response. The buyer or seller must log into the system to view the message and may respond to the message by typing a message into the system.

Once the buyer has decided to purchase a good or service from the seller, the seller may log into the system to indicate agreement and the transaction processing capability becomes available for the buyer to pay the seller. Alternatively, when the seller responds to the buyer that they agree to the terms, the seller may enter specific terms or codes into the email response that the system reads and automatically enables the transaction processing capability. The dollar amount for the transaction is set by the seller either by logging into the system or using specific terms or codes in the email message. The buyer logs into the system and initiates the transaction for the amount agreed to and is already shown in the system. The system receives the money, deducts a system fee, and then sends the rest of the money to the seller. When the seller receives the money, they ship the good to the buyer or initiate providing the service.

When a buyer does not locate a desired good or service on the system, the buyer may be notified when a desired good or service is offered by a seller on the system. The desired good or service is based upon the match score calculated by the matching algorithm as set forth above. The buyer may select different values for the match score and the system will then show them the exact goods or services currently listed for sale that meet the criteria. By examining the goods or services on the list using different match score values, the buyer can select a value for the match score they would like to have used for notifications of new goods or services listed for sale. The buyer does not need to know they are selecting a value for the match score. Instead, the system can present the match score as a value from 1 to 100 where the buyer believes they are selecting from a percent match with higher percent match values being associated with lower match scores. The concept of match score may confuse many users of the system. The buyer may set a date at which they would like the notifications to cease.

During use, as sellers list additional items and services for sale, the match score for all buyers have requested notification for the specific item is calculated. If the match score is within the match threshold set by the buyer, the buyer is notified.

The system allows a buyer to rate a seller, and a seller to rate a buyer. The rating system is based upon the quality of the transaction. The rating system is to instill a level of confidence in the buyer that the seller is reputable, assuming the seller has been given positive rankings. The buyer is ranked also to provide information to a seller about the buyer. This allows sellers to gain knowledge of the payment history of the buyer. Both buyers and sellers can review all rankings given to each other.

In another exemplary embodiment of the present invention, relevant content other than goods or services may appear on a user's screen. This content is based upon the information entered into the system by the user and the matching score generated by the user. This relevant content may be articles, books excerpts, a CarFax® data report and the like. In this alternative embodiment, articles associated with the goods or services sought by the buyer will appear on the screen. Preferably, links to the articles will appear on the screen for the user to be directed. The articles that appear will be related to the goods or services. In other words and by way of an example, if a buyer is seeking to purchase a computer, an article (or preferably articles) about the particular computer will be presented to the buyer for viewing. The article can include product reviews and the like for the buyer to review prior to purchase. The content such as articles may also allow the viewer to search for additional content online. This can be accomplished with the use of display links inserted into the article. For Example, the author or publisher of the article can flag or select words in the text to be used as key words or search terms. When the article is published in the online environment a search is conducted to locate relevant information and content. This additional content is available to the user by clicking on the link that may either be the actual key word that was flagged or selected or the user may click an icon located in close proximity to the key word.

Further, all words, drawings, pictures, and photographs may be searched to produce relevant content. The user may run across a word within the article that they are unsure of the definition, and by clicking on the word, they user is directed to a definition of the word. This embodiment allows all words and items within an article to be searched.

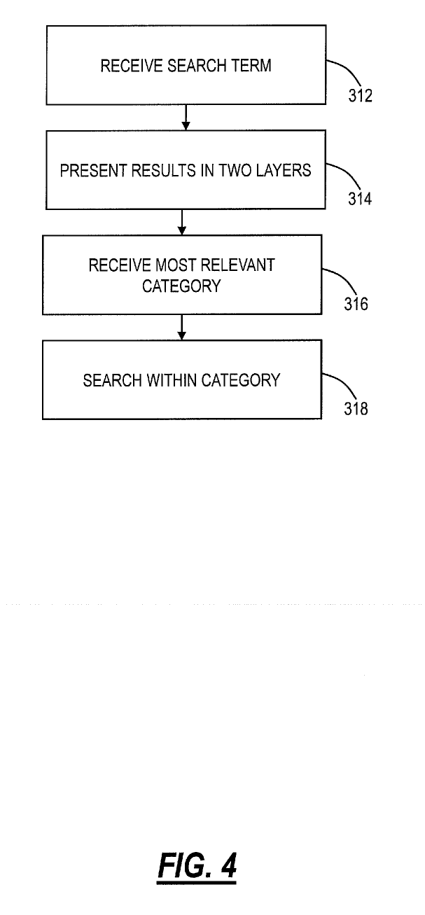

As illustrated in FIG. 4, in yet another exemplary embodiment, the system 10 includes the search engine 14 that crawls the web searching for search terms. These search terms and associated pages are stored within the system 10. When a user types a search term into the search engine (step 312), the search engine presents the results in two layers (step 314). The first layer yields high level aggregated classifications. These classifications can be created by aggregating common terms or words into logical groupings or can also be created by users who have pre-drafted the categories in a virtual manner, collaboratively. For example, a user types in “Bjorn” to the search engine and the first layer results would yield 1) the first ten or top ten matches or searches, 2) shoes and shoe companies, shoe models, shoe types, 3) tennis player, 4) surname, 5) geography and places, 6) companies and industries, and 7) colloquialisms. The results are presented to the user in visual format to aid the user in quickly determining if a category exists. If the category does not exist, the user may select the most relevant category, which will then begin the second layer search (step 316). Alternatively, the user may enter another search term to generate a second layer search (step 318).

By way of example only, the user may select shoes from the first layer list. The second layer list would be another round of results that are focused exclusively on shoes. Categories that may be listed in the second layer are: 1) seasonal footwear, 2) shopping and gifts, 3) gender specific, 4) shoes by color, 5) countries of manufacture, 6) retail outlets, 7) retailers in vicinity, and 8) shopping assistance. The user may select the appropriate categories, but if none of the categories are appropriate, the user may select the most appropriate category for the search engine to begin a third layer search. The third layer search narrows the field of possible matches, much like the second layer. The benefits of these layers searches is to allow the user the capability to quickly sift through very arcane topics and terms without the need to manually sift through hundreds or dozens of pages from a typical search engine. The user also controls the search engine at each level.

When an article or informational document is viewed online, the present invention includes the ability to search for other related content then potentially display links to additional online content related to the article or document being viewed. One specific example is related to newspaper articles. When the article is printed and the paper is delivered subscribers to the “print” edition can read the article. Currently some newspapers put their entire content online where readers can view it for free and not pay for a subscription to the “print” edition. The business problem to be solved is how to deliver additional value added content on a newspaper web site worthy of charging a subscription fee. With the “content to content” concept when a newspaper article is displayed online additional online content can be made available to “online” subscribers.

One exemplary embodiment of this concept is for an author of a newspaper article to “flag” words in the text to be used as “key words” or “search terms” for the “content to content” search. The “flags” are created within Extensible Markup Language (XML) and they are not printed in the “print” edition. When the article is moved into the “online” environment a process recognizes the “flags” and an online search is performed using the “key words” to locate related content and create links that will be presented to “online” subscribers. Suppose there is an article in the newspaper about an earthquake in a certain part of the world. The “content to content” concept could be used to search online for content about the fault line where the earthquake occurred, other earthquakes with about the same intensity, other articles about the same earthquake, previous predictions of an earthquake in that part of the world, population density where the earthquake occurred, etc. This concept is not limited to the scenario where “key words” or “search terms” are “flagged” in the text or provided. Specifically, this concept may include the ability to select key words from the content the same way key words are selected from ads to present related content.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method of generating search results, the method comprises:
submitting a first search query for searching a first level database that yields high level aggregated classifications;
obtaining high level aggregated classifications based upon the first search query;
submitting a second search query based upon the high legal aggregated classifications of the first search query; and
obtaining focused results based upon the second search query.

2. The method of claim 1, further comprising providing database of stored search terms and pages.

3. The method of claim 1, further comprising submitting a third search query based upon the focused results based upon the second search query.

4. The method of claim 1, further comprising submitting an expiration date for removing results from a search.

5. The method of claim 1, further comprising submitting a detailed description for inclusion with the results from the search.

6. The method of claim 1, further comprising submitting a rank based upon experiences encountered during the search.

7. A method of generating search results, the method comprises:
providing a server and at least one user terminal that is coupled to the server, a first user and a plurality of second users;
submitting a first search query by the first user for searching a first level database that yields high level aggregated classifications related to inputs from the plurality of second users;
obtaining high level aggregated classifications based upon the first search query;
ranking the aggregated classifications obtained for the first user;
submitting a second search query by the based upon the high legal aggregated classifications of the first search query;
obtaining focused results based upon the second search query.

8. The method of claim 7, wherein the first user is a buyer and wherein the plurality of second users are sellers.

9. The method of claim 7, further comprising providing a database of stored terms and pages.

10. The method of claim 7, further comprising submitting a third search query based upon the focused results of the second search query.

11. The method of claim 7, further comprising submitting an expiration date for removing results from a search.

12. The method of claim 7, further comprising displaying content relevant to the results obtained based upon the second search query.

13. The method of claim 8, wherein the content is searchable, thus allowing the first user to search terms contained within the content.

14. A system for generating search results, comprising:
a local interface;
a data store;
a processor coupled to the local interface and the data store, wherein the processor is configured to receive the submission of a first query for searching a first level database that yields high level aggregated classifications related to inputs, obtain high level aggregated classifications based upon the first search query, rank the aggregated classifications obtained, submit a second search query based upon the high level aggregated classifications, and present a search result based upon the description submitted by the seller and the search query submitted by the buyer.

15. The system of claim 14, further comprising memory that may be accessed by the processor.

16. The system of claim 14, wherein the processor is configured to allow the selection of a particular search result by the buyer based upon the search results presented.

17. A system of claim 14, wherein the processor is configured for creating a matching algorithm that matches a particular good or service for sale by the seller to a good or service desired by a buyer based upon the description submitted by the seller and the search query submitted by the buyer.

18. The system of claim 14, wherein the processor is configured to receive a photograph of the good offered for sale by the seller.

19. The system of claim 14, wherein the processor is configured to provide notification to the buyer or the seller that the other party wishes to communicate.

20. A content to content method, comprising:
providing a server and at least one user terminal that is coupled to the server over a network;
providing content from the server to the at least one user terminal;
flagging one or more words in the content to be used as terms for a content to content search, wherein the flagging utilizes Extensible Markup Language;
performing the content to content search by looking up related content based on the one or more words; and
providing the related content to the at least one user terminal.
